(19) United States
(12) Patent Application Publication
(10) Pub. No.: US 2014/0126088 A1
(43) Pub. Date: May 8, 2014

(54) PROTECTION CIRCUIT, SWITCH CONTROL CIRCUIT, AND POWER SUPPLY DEVICE COMPRISING THE SAME

(71) Applicant: Fairchild Korea Semiconductor LTD., Bucheon (KR)

(72) Inventors: In-Ki PARK, Seoul (KR); Gye-Hyun CHO, Incheon-si (KR)

(73) Assignee: Fairchild Korea Semiconductor LTD., Bucheon (KR)

(21) Appl. No.: 14/071,863

(22) Filed: Nov. 5, 2013

(30) Foreign Application Priority Data
Nov. 5, 2012 (KR) 10-2012-0124394

(51) Int. Cl. H02H 7/12; H02H 9/04

(52) U.S. Cl. CPC H02H 7/12; H02H 9/041
USPC 361/18; 361/56

(57) ABSTRACT

Exemplary embodiments relate to a protection circuit, a switch circuit, and a power supply device including the same. The protection circuit includes: a detection circuit that generates a detection voltage that is increased by fluctuation of a comparison voltage; and an SCR (Silicon-Controlled Rectifier Thyristor) that includes a gate where the detection voltage is inputted, an anode electrically connected to a power voltage, and a cathode connected to a predetermined reference voltage, which is turned on when the detection voltage is inputted in the gate, and is turned off when a current does not flow to the anode.

### CROSS-REFERENCE TO RELATED APPLICATION

This application claims priority to and the benefit of Korean Patent Application No. 10-2012-0124394 filed in the Korean Intellectual Property Office on Nov. 5, 2012, the entire contents of which are incorporated herein by reference.

### BACKGROUND

(a) Field

Embodiments relate to a protection circuit, a switch control circuit, and a power supply device using the circuits.

(b) Description of the Related Art

When a converter, an example of power supply devices, malfunctions, a protection operation starts. For example, when a malfunction of a converter is sensed and a protection operation starts, the power voltage supplied to a converter control IC starts to reduce.

When the converter malfunctions, the power voltage supplied to the converter control IC starts to reduce for the protection operation, and when the power voltage drops to a threshold level, the control IC stops operating. However, the power voltage of the control IC automatically restarts, after dropping to the threshold level, so that switching is repeated, which causes a loss of power.

While the power voltage drops to the threshold level, the converter control IC repeats automatic restarting. That is, switching is repeated. This causes a loss of power.

The above information disclosed in this Background section is only for enhancement of understanding of the background of the invention and therefore it may contain information that does not form the prior art that is already known in this country to a person of ordinary skill in the art.

### SUMMARY

Embodiments provide a protection circuit, a switch control circuit, and a power supply device including the circuits having advantages of preventing a loss of power due to automatic restart in an abnormal status.

According to an embodiment, a protection circuit includes: a detection circuit that generates a detection voltage that is increased by fluctuation of a comparison voltage; and an SCR (Silicon-Controlled Rectifier Thyristor) that includes a gate where the detection voltage is inputted, an anode electrically connected to a power voltage, and a cathode connected to a predetermined reference voltage. The SCR is turned on based on the input of the gate, and is turned off when a current does not flow to the anode.

The detection circuit includes: a first capacitor that has one end where a comparison voltage is inputted; a first diode that includes an anode connected to the other end of the capacitor; a second capacitor that is connected between a cathode of the first diode and the reference voltage; and a second diode that includes an anode connected to the other end of the first capacitor and a cathode connected to the other end of the first capacitor. The detection voltage connected with the cathode of the first diode and the second capacitor.

The protection circuit further includes an amplifying unit that connects the power voltage with a gate of the SCR based on the detection voltage.

The amplifying unit includes a BJT including a base electrically connected to the detection voltage, a collector electrically connected to the power voltage, and an emitter connected to the gate of the SCR.

The protection circuit further includes a first resistor connected between the base of the BJT and the detection voltage.

The protection circuit further includes a second resistor connected between the collector and the power voltage.

The protection circuit further includes a third resistor connected between the anode of the SCR and the power voltage.

According to another embodiment, a switch control circuit controls switching of a power supply device, which includes primary wire, a secondary wire, a power switch connected to one end of the primary wire, and an auxiliary wire disposed at the primary side, insulated and coupled to the secondary wire.

The switch control circuit includes: a Tdis detecting unit that detects a Tdis time from a time when a current is generated in the secondary wire to a time when the current flowing through the secondary wire reaches zero by using an auxiliary voltage that is the voltage between both ends of the auxiliary wire; and a current calculating unit that calculates an output current of the power supply device by using the Tdis time and a current sensing voltage based on the current flowing through the power switch to generate an output power sensing voltage.

The switch control circuit generates a power voltage by using the auxiliary voltage and a comparison voltage based on the difference between the output current sensing voltage and a predetermined output reference voltage, and is connected to a protection circuit that generates a detection voltage increased by fluctuation of the comparison voltage in an abnormal status and controls the power voltage to a predetermined reference voltage when the detection voltage reaches a predetermined protection operation threshold level.

The protection circuit includes an SCR (Silicon-Controlled Rectifier Thyristor) that includes a gate that the detection voltage is inputted, an anode electrically connected to the power voltage, and a cathode connected to the reference voltage is turned on/off in response to the input of the gate.

The protection circuit includes: a first capacitor that has one end where a comparison voltage is inputted; a first diode that includes an anode connected to the other end of the capacitor; a second capacitor that is connected between a cathode of the first diode and the reference voltage; and a second diode that includes an anode connected to the other end of the first capacitor and a cathode connected to the other end of the first capacitor. The detection voltage is the voltage of the node where the cathode of the first diode and the second capacitor are connected.

The protection circuit further includes an amplifying unit that connects the power voltage with a gate of the SCR based on the detection voltage.

The amplifying unit includes a BJT including a base electrically connected to the detection voltage, a collector electrically connected to the power voltage, and an emitter connected to the gate of the SCR.

The Tdis detecting unit senses an end time of the Tdis time when the sensing voltage rapidly decreases, and detects the time from a time when the sensing voltage begins to increase to the end time of the Tdis time as the Tdis time, by sampling and holding a sensing voltage from the auxiliary voltage which is divided by resistors, and sets a predetermined reference Tdis time as the Tdis time, when failing to sense the end time of the Tdis time in the abnormal status.

The current calculating unit generates the output current sensing voltage, based on the result of multiplying the Tdis time by the current sensing voltage at the turn-off point of time of the power switch.

The switch control circuit further includes a low-voltage comparing unit that generates a power status signal based on the result of comparing the power voltage with a first low-voltage reference voltage, when the power voltage decreases, or the result of comparing the power voltage with a second low-voltage reference voltage, when the power voltage increases, and the switch control circuit discharges the capacitor storing the comparison voltage, when the power status signal is at a disabled level.

The switch control circuit further includes an OVP (Over Voltage Protection) comparator that generates a shutdown signal based on the result of comparing the power voltage with a predetermined overvoltage reference voltage, and discharges the capacitor storing the comparison voltage, when the power voltage reaches a first low-voltage reference voltage due to the shutdown signal.

According to another embodiment, a power supply device includes: a transformer that includes a primary wire and a secondary wire; a power switch that is connected to one end of the primary wire; an auxiliary wire that is disposed at the primary side, insulated and coupled to the secondary wire; a first capacitor that is connected to an auxiliary voltage, which is the voltage between both ends of the auxiliary wire, through a diode, and stores a power voltage; a switch control circuit that detects a Tdis time from a time when a current is generated in the secondary wire to a time when the current flowing through the secondary wire reaches zero by using the auxiliary voltage, calculates an output current of the power supply device by using the Tdis time and a current sensing voltage based on the current flowing through the power switch to generate an output power sensing voltage, and generates a comparison voltage based on the difference between the output current sensing voltage and a predetermined reference voltage; and a protection circuit that generates a detection voltage increased by fluctuation of the comparison voltage in an abnormal status, and controls the power voltage to a predetermined reference voltage, when the detection voltage reaches a predetermined protection operation threshold level.

The protection circuit includes an SCR (Silicon-Controlled Rectifier Thyristor) that includes a gate that the detection voltage is inputted, an anode electrically connected to the power voltage, and a cathode connected to the reference voltage, is turned on/off in response to the input of the gate.

The protection circuit includes: a first capacitor that has one end where the comparison voltage is inputted; a first diode that includes an anode connected to the other end of the capacitor; a second capacitor that is connected between a cathode of the first diode and the reference voltage; and a second diode that includes an anode connected to the other end of the first capacitor and a cathode connected to the other end of the first capacitor, in which the detection voltage connected with the cathode of the first diode and the second capacitor.

The protection circuit further includes an amplifying unit that connects the power voltage with a gate of the SCR based on the detection voltage.

Exemplary embodiments provide a protection circuit, a switch control circuit, and a power supply device, which prevent power consumption that is generated by automatic restarting in an abnormal status.

### BRIEF DESCRIPTION OF THE DRAWINGS

FIG. 1 is a diagram illustrating a protection circuit according to an exemplary embodiment.

FIG. 2 is a diagram illustrating a protection circuit according to another exemplary embodiment.

FIG. 3 is a diagram illustrating a PSR converter according to another exemplary embodiment.

FIG. 4 is a waveform diagram illustrating a sensing voltage, a secondary current, and an auxiliary sensing voltage according to another exemplary embodiment.

FIG. 5 is a diagram illustrating a portion of the configuration of a switch control circuit according to another exemplary embodiment.

### DETAILED DESCRIPTION OF THE EMBODIMENTS

In the following detailed description, only certain exemplary embodiments have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

A protection circuit according to an exemplary embodiment and a converter including the protection circuit are described hereafter with reference to the drawings.

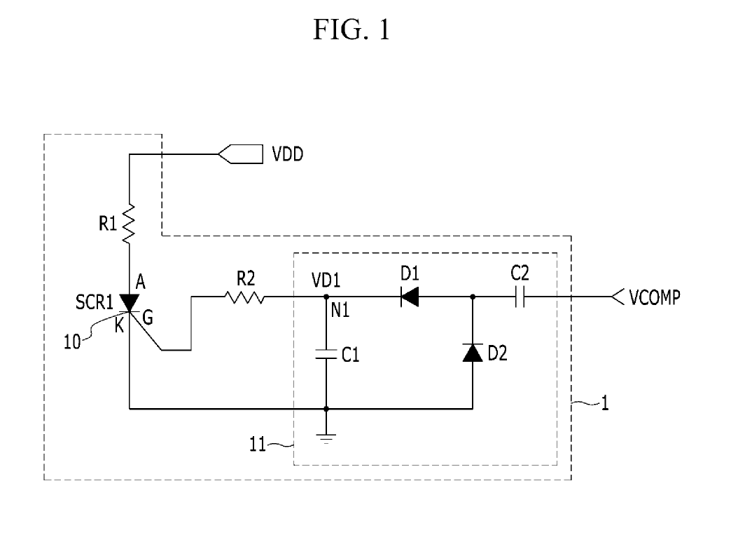

FIG. 1 is a diagram illustrating a protection circuit according to an exemplary embodiment.

A protection circuit 1 maintains a power voltage VDD at a predetermined reference voltage in accordance with a comparison voltage VCOMP. The reference voltage of the protection circuit 1 is set at the ground voltage, but exemplary embodiments are not limited thereto.

When the comparison voltage VCOMP fluctuates, a capacitor C1 is charged with the comparative voltage VCOMP. An SCR1 (Silicon-Controlled Rectifier Thyristor) 10 is turned on by the voltage charging the capacitor C1. When SCR1 2 is turned on, the power voltage VDD is connected to the ground through a resistor R1.

When the current flowing through an anode becomes 0, the SCR1 10 is turned off. For example, current stops flowing to the anode, the time when the power voltage VDD drops and reaches the ground level. Therefore, the SCR1 10 is turned off, when the power voltage VDD reaches the ground level.

The protection circuit 1 includes the SCR1 10, a detection circuit 11, and two resistors R1 and R2. The detection circuit 11 generates a detection voltage VD1 with an increase in the comparison voltage VCOMP.

The detection circuit 11, for example, may include two diodes D1 and D2, and two capacitors C1 and C2. However, exemplary embodiments are not limited thereto. One end of the capacitor C2 is connected to the comparison voltage VCOMP and the other end of the capacitor C2 is connected to the anode of the diode D1 and the cathode of the diode D2.

The cathode of the diode D1 is connected to one end of the capacitor C1 and the anode of the diode D2 is connected to the other end of the capacitor C1 and connected to the ground. The detection voltage is the voltage of a node N1 to which the cathode of the diode D1 and one end of the capacitor C2 are connected.

The SCR1 10 includes an anode A, a cathode K, and a gate G, is turned on, when the voltage supplied to the gate G is a predetermined voltage or more, and is turned off, when the current supplied to the anode A is cut.

The resistor R1 is connected between the anode A and the power voltage VDD and the resistor R1 is connected between the detection voltage VD1 and the gate G. The capacitor C1 is connected to the power voltage VDD.

When the comparison voltage VCOMP fluctuates, energy is transmitted to the capacitor C1 through the capacitor C2 and the detection voltage VD1 is generated

For example, when the comparison voltage VCOMP fluctuates, repeating increasing and decreasing, the detection voltage VD increases.

In detail, as the comparison voltage VCOMP increases, the voltage at the other end of the capacitor C2 increases and the diode D1 is conducted. The energy charged in the capacitor C2 charges the capacitor C1 through the conducted diode D1 and the detection voltage VD1 increases.

When the detection voltage VD1 does not reach the level capable of turning on the SCR1 10, the comparison voltage VCOMP increases back due to restart of the control IC, the voltage at the other end of the capacitor C2 increases back, and the diode D1 is conducted. Accordingly, the detection voltage VD1 is increased, by the charging of the capacitor C1.

While the comparison voltage VCOMP increases in the fluctuation (hereafter, fluctuation time), the detection voltage VD1 simultaneously increases and the voltage supplied to the gate G becomes a predetermined voltage or more by the detection voltage VD1, such that the SCR1 10 is turned on. When the voltage supplied to the gate G is the predetermined voltage, the level of the detection voltage VD1 is called a protection operation threshold level.

When the SCR1 10 is turned on, the power voltage VDD is connected to the ground through the resistor R1 and the SCR1 10 which is turned on. The SCR1 10 keep on until a current flowing through the SCR1 10 and the resistor R1 from the power voltage VDD becomes 0. Thereafter, when the input power is cut, the power voltage VDD of the control IC is also cut, such that the current cannot flow to the SCR1 10 any more and the SCR1 10 is turned off.

Exemplary embodiments are not limited to the exemplary embodiment illustrated in FIG. 1 and may be modified in various ways.

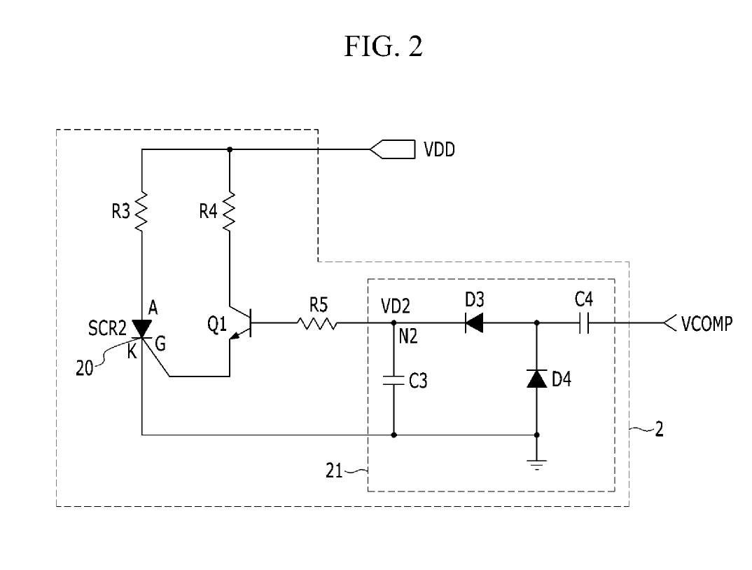

FIG. 2 is a diagram illustrating a protection circuit according to another exemplary embodiment.

If a comparison voltage VCOMP is high enough to generate a gate voltage at a lever capable of turning on an SCR, a means for amplifying the voltage that is supplied to the gate of the SCR may not be needed. However, the comparison voltage VCOMP may not be high enough and an amplifying unit for turning on the SCR more stably may be further included in the protection circuit.

The protection circuit 2 includes an SCR2 20, a detection circuit 21, three resistors R3, R4, and R5, and a BJT Q1. As illustrated in FIG. 2, the protection circuit 2 further includes the BJT Q1 having a collector connected to a power voltage VDD through a resistor R4, in comparison to the protection circuit 1. The BJT1 Q1 is just an example of an amplifying unit in another exemplary embodiment and exemplary embodiments are not limited thereto.

The SCR2 20 includes an anode A, a cathode K, and a gate G, and the gate G is connected to an emitter of the BJT Q1 and turned on, when the voltage supplied to the gate G is a predetermined voltage or more. The SCR2 20 is turned off, when the current supplied to the anode A is cut.

The base of the BJT Q1 is connected to the output terminal, that is, the node N2, of the detection circuit 21 through the resistor R5. The detection voltage VD2 of the detection circuit 21 is the voltage of the node N2.

The detection circuit 21 includes two diodes D3 and D4 and two capacitors C3 and C4. The connections of the parts and the operation of the detection circuit 21 are the same as those of the detection circuit 11 described above and are not described.

The detection voltage VD increases and reaches to a level capable of turning on the BJT Q1, during the fluctuation time. Then, the gate G can be connected to the power voltage VDD through the resistor R4. The SCR2 20 is turned on by the power voltage VDD and the power voltage VDD drops to a ground level and keeps at the level.

The SCR2 20 is turned off, when the current supplied to the anode is cut.

A power supply device including the protection circuit according to the exemplary embodiments is described hereafter. There is provided a PSR (Primary Side Regulation) converter as an example of a power supply device.

For example, the PSR converter uses au auxiliary wire to acquire feedback information. The auxiliary wide is positioned at the primary side of a transformer of the converter and is insulated and coupled to the secondary wire with a predetermined winding ratio.

When all the energy stored in the primary wire is transmitted to the secondary side and the secondary current does not flow, the drain-source voltage of the power switch makes a fluctuation waveform by resonance. The waveform of the drain-source voltage is applied to the voltages at both ends of the auxiliary wire (hereafter, auxiliary voltages).

When the secondary current supplied to the output terminal decreases to a zero current while the power switch is turned off, a time for when the auxiliary voltage rapidly decreases is generated. The PSR converters of the related art acquire feedback information for controlling the operation of a power switch by sensing the time when the voltage of an auxiliary wire rapidly decreases.

However, an output voltage is not generated, when a short circuit occurs at the output, such that the auxiliary voltage does not rapidly decrease. The PSR converters acquire feedback information saying that the output power is small. Therefore, a malfunction that increases the on-time of the power switch to increase the output power when a short circuit occurs at the output terminal is generated and repeated in the PSR converters.

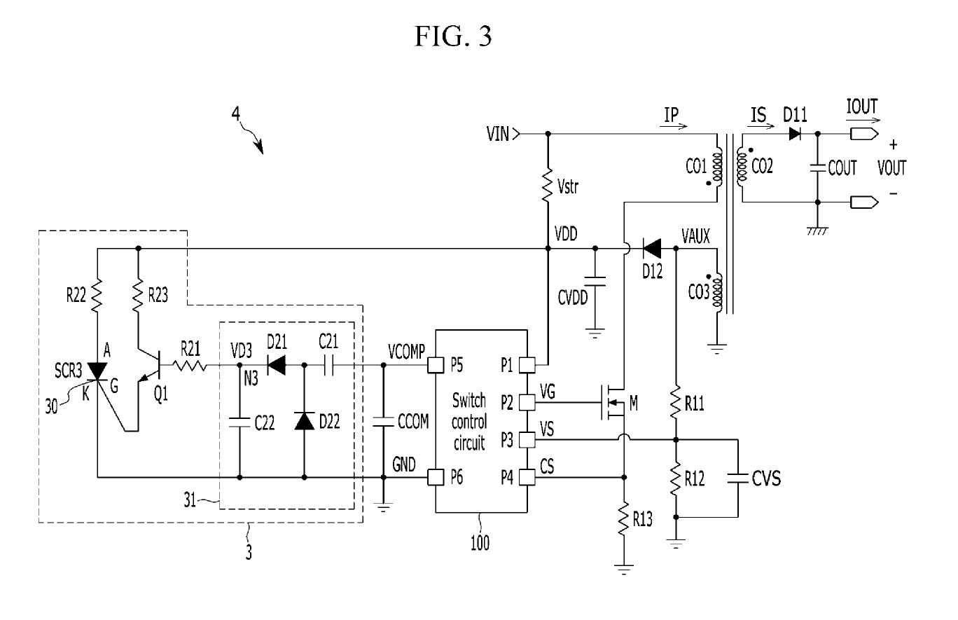

A PSR converter according to another exemplary embodiment is described hereafter with reference to FIG. 3.

FIG. 3 is a diagram illustrating a PSR converter according to another exemplary embodiment. As illustrated in FIG. 3, a PSR converter 4 includes a protection circuit 3. The protection circuit 3 is implemented in the structure following the exemplary embodiment illustrated in FIG. 2. However, exemplary embodiments are not limited thereto and may be implemented in the structure following the exemplary embodiment illustrated in FIG. 1.

The PSR converter 4 includes a primary wire CO1, a secondary wire CO2, au auxiliary wire CO3, a power switch M, a rectifier diode D11, a diode D12, capacitors CVDD, CCOM, and CVS, a protection circuit 3, a switch control circuit 100, and three resistors R11, R12, and R13.

The primary wire CO1 and the secondary wire CO2 form a transformer. The auxiliary wire CO3 is positioned at the primary side, insulated and coupled to the secondary wire CO2 with a predetermined wiring ratio.

An input voltage VIN is connected to one end of the primary wire CO1 and the drain of the power switch M is connected to the other end of the primary wire CO1. The anode of the rectifier diode D11 is connected to one end of the secondary wire CO2 and the other end of the secondary wire CO2 is connected to the ground.

An output capacitor COUT has one end connected to a first output terminal (+) and the cathode of the rectifier diode D11 and the other end connected to the secondary ground. A second output terminal (−) is connected to the secondary ground, the first output terminal (+) and the second output terminal (−) are connected to a load, and the voltage between the output terminals (+ and −) is an output voltage.

The anode of the diode D12 is connected to one end of the auxiliary wire CO3 and the capacitor CVDD is connected to the cathode of the diode D12. One end of the capacitor CVDD is connected to the input voltage VIN through a start resistor Vstr and the other end of the capacitor CVDD is connected to the primary ground. The capacitor CVDD is charged by the current flowing through the conducted diode D12 and generates the power voltage VDD.

The resistor R13 is connected between the source of the power switch M and the primary ground and a current sensing voltage CS following the current flowing through the power switch M is generated by the resistor R13.

The resistors R11 and R12 are connected in series between one end of the auxiliary wire CO3 and the primary ground and a sensing voltage VS is generated at the node N3 where the resistors R11 and R12 are connected. The capacitor CVS is connected between the node N3 and the ground and filters the noise component of the sensing voltage VS.

A gate voltage VG is supplied to the gate of the power switch M and the power switch M is connected to one end of the resistor R13. The other end of the resistor R13 is connected to the primary ground. Although the power switch M is implemented by an N channel transistor, exemplary embodiments are not limited thereto.

A primary current IP flows through the primary wire CO1 and energy is stored in the primary wire CO1 while the power switch M keeps on. The primary current IP increases and the secondary current IS does not flow because the rectifier diode D11 is the off state while the power switch M keeps on. The voltages at both ends of the auxiliary wire CO3, that is, the auxiliary voltage VAUX keeps constant, as a negative voltage, and the diode D12 is in the off state.

The energy stored in the primary wire CO1 is transmitted to the secondary side while the power switch M keeps off. In detail, as the power switch M is turned off, the primary current IP does not flow and the rectifier diode D11 is conducted, such that the secondary current IS flows. The secondary current IS decreases and reaches to zero while the power switch M keeps off.

At the time when the power switch M is turned off, the auxiliary voltage VAUX increases to a positive voltage obtained by multiplying the voltages at both ends of the secondary wire CO2 by the wiring ratio (the wiring number of the auxiliary wire/the wiring number of the secondary wire). Thereafter, the auxiliary voltage VAUX gradually decreases and rapidly decreases, at the time when the secondary current IS reaches zero.

The switch control circuit 100 detects the time (hereafter, Tdis period) from the time when the auxiliary voltage VAUX increases (the power switch M is turned off) to the time when the auxiliary voltage VAUX rapidly decreases. It is possible to calculate an information rule about the output current IOU, when knowing the Tdis time. The switch control circuit 100 detects the Tdis period, using the sensing voltage VS corresponding to the auxiliary voltage VAUX.

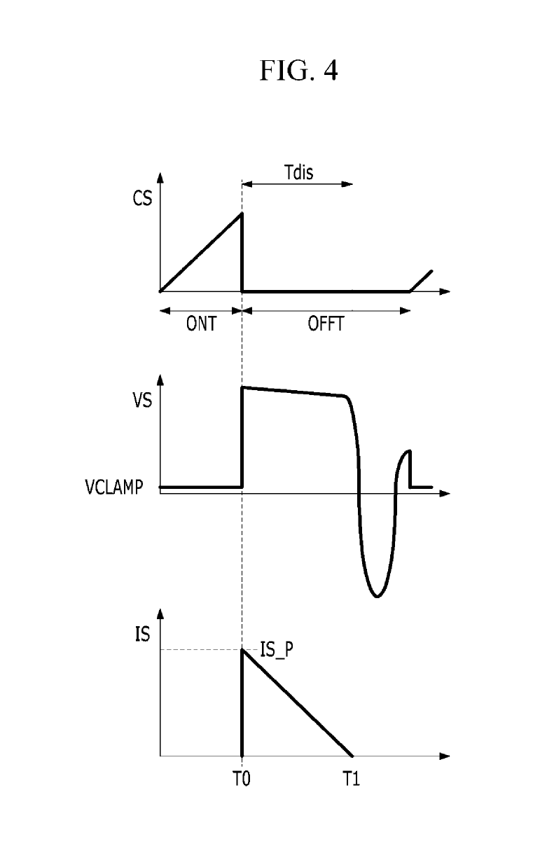

FIG. 4 is a waveform diagram illustrating a sensing voltage, a secondary current, and an auxiliary sensing voltage according to another exemplary embodiment.

As illustrated in FIG. 4, the current sensing voltage CS increases when the power switch M keeps on (ONT), and is a zero voltage while the power switch M keeps off (OFFT). The secondary current IS is generated, the off-point of time T0 of the power switch, and it decreases and reaches to zero for the time T0-T1. That is, the Tdis time is T0-T1.

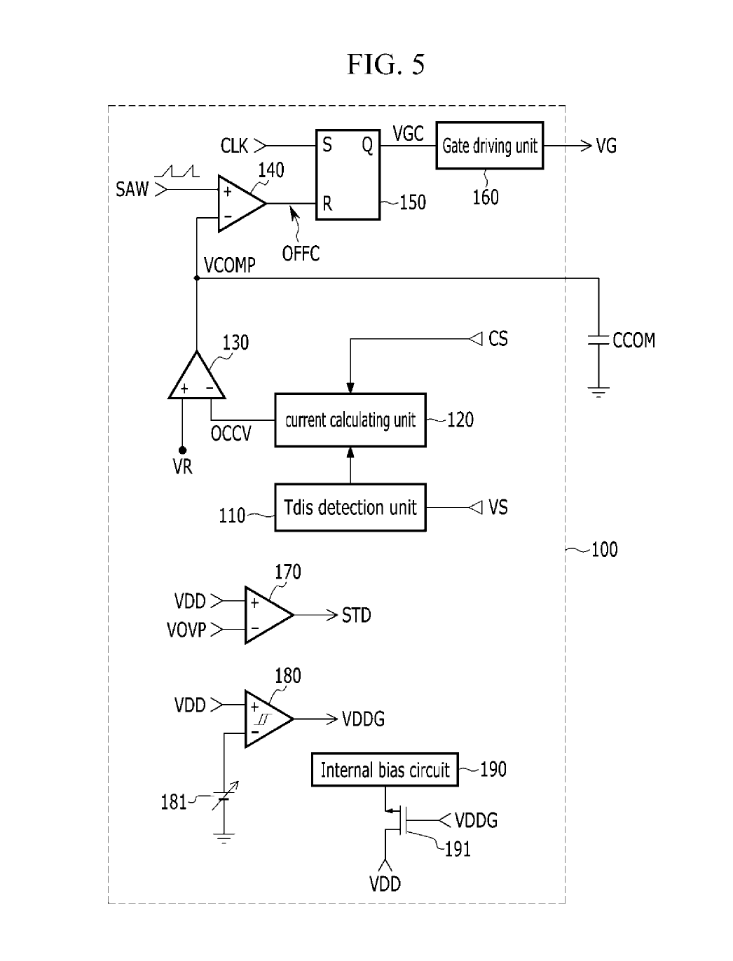

The sensing voltage VS may be clamped to a negative voltage or a predetermined clamping voltage for the time ONT. As illustrated in FIG. 5, the switch control circuit 100 clamps the sensing voltage VS to a clamping voltage VCLAMP.

The sensing voltage rapidly increases at the turn-off point of time T0 and rapidly decreases, at the point of time T1 where the secondary current IS is removed.

The output current IOUT is the area where the secondary current IS is generated for the time ONT and OFFT, that is, for one cycle of switching, such that it can be calculated from the following Equation 1.

IOUT=½*(IS_{—}P)*Tdis (Equation 1)

The peak IS_P of the secondary current is the value obtained by multiplying the peak IP_P of the primary current by the wiring ratio (the primary wiring number/secondary wiring number, hereafter, NPS). This follows Equation 2.

IS_{—}P=IP_{—}P*NPS (Equation 2)

The peak IP_P of the primary current is the primary current IP at the turn-off point of time T0, such that it is “CS_P/R13”. The CS_P is a current sensing voltage CS_P at the turn-off point of time. Therefore, it is possible to calculate the output current IOUT for one cycle of switching from the following Equation 3.

IOUT=½*(CS_{—}P/R13)*NPS*Tdis Equation 3)

As illustrated in FIG. 4, the sensing voltage VS starts to rapidly decrease at the point of time T1 and this position is the same as the time when the secondary current IS is removed. Therefore, the switch control circuit 100 can sense the point of time T1 where the sensing voltage VS rapidly decreases and can detect the Tdis time, by sampling and holding the sensing voltage VS. R13 and NPS are fixed values in Equation 3.

Therefore, the switch control circuit 100 can calculate the output current IOUT by sensing the current sensing voltage CS_P at the turn-off point of time and detecting the Tdis time

In the switch control circuit 100, a connection pin P1 connected to the power voltage VDD, a connection pin P2 connected to the gate of the power switch M, a connection pin P3 connected to the sensing voltage VS, a connection pin P4 connected to the current sensing voltage CS, a connection pin P5 connected to the comparison voltage VCOMP, and a connection pin P6 connected to the primary ground are formed.

In detail, the switch control circuit 100 is supplied with power voltage VDD through the connection pin P1, outputs the gate voltage VG through the connection pin P2, receives the sensing voltage inputted through the connection pin P3, and receives the current sensing voltage CS inputted through the connection pin P4.

The switch control circuit 100 calculates the output current from the current sensing voltage CS.

The switch control circuit 100 is connected to the ground through the connection pin P6. The capacitor CCOM is connected between the connection pin P5 and the ground and used to generate the comparison voltage VCOMP.

FIG. 5 is a diagram illustrating a portion of the configuration of a switch control circuit according to another exemplary embodiment.

As illustrated in FIG. 5, the switch control circuit 100 includes a Tdis detecting unit 110, a current calculating unit 120, an error amplifier 130, a PWM comparator 140, an SR flip-flop 150, a gate driving unit 160, an OVP comparator 170, a low-voltage comparator 180, and an internal bias circuit 190.

The internal bias circuit 190 receives the power voltage VDD and generates a bias voltage for the operation of the switch control circuit 100. The internal bias circuit 190 is connected to the power voltage VDD through the transistor 191. While the transistor 191 is turned on by the high level of a power status signal VDDG, the power voltage VDD is supplied to the internal bias circuit 190.

While the transistor 191 is turned off by a low level of the power status signal VDDG, the power voltage VDD is not supplied to the bias circuit 190. When the power voltage VDD supplied to the internal bias circuit 190 is cut, the switch control circuit 100 stops operating.

The low-voltage comparator 180 generates a power status signal VDDG in accordance with the result of comparing the power voltage VDD with the voltage of the voltage source 181. The voltage source 181 supplies a first low-voltage reference voltage and a second low-voltage reference voltage. The first low-voltage reference voltage is supplied to an inverting terminal (−) of the low-voltage comparator 180, when the power voltage VDD decreases, and the second low-voltage reference voltage is supplied to an inverting terminal (−) of the low-voltage comparator 180, when the power voltage VDD increases. The first low-voltage reference voltage is lower than the second low-voltage reference voltage.

When the power voltage VDD at the normal level decreases lower than the first low-voltage reference voltage, the low-voltage comparator 180 generates a power status signal VDDG at a low level. When the power voltage VDDG at an abnormal level (for example, lower than the first low-voltage reference voltage) increases above the second low-voltage reference voltage, the low-voltage comparator 180 generates a power status signal VDDG at a high level.

The OVP (over voltage protection) comparator 170 generates a shutdown signal STD at a high level, when the power voltage VDD is an OVP reference voltage VOVP or more. The switch control circuit 100 stops operating, when a shutdown signal STD at a high level is generated. For example, the gate driving unit 160 is disabled by a shutdown signal STD at a high level and does not generate a gate voltage VG.

The switch control circuit 100 rapidly decreases the comparison voltage VCOMP by discharging the capacitor CCOM, when a power status signal VDDG at a low level is generated by a shutdown signal STD at a high level. The low level of the power status signal VDDG due to the shutdown signal STD is an example of a disabled level and exemplary embodiments are not limited thereto.

The PWM comparator 140 receives a saw-toothed wave SAW and the comparison voltage VCOMP and generates an off-control signal OFFC for determining turning-off the power switch M in accordance with the result of comparing the saw-toothed wave SAW with the comparison voltage VCOM. The saw-toothed wave SAW is a signal that increases while the power switch M keeps on. The comparison voltage VCOMP is inputted to the inverting terminal (−_and the saw-toothed wave SAW is inputted to a non-inverting terminal (+).

The PWM comparator 140 generates an off-control signal OFFC at a high level, when the input of the non-inverting terminal (+) is the input of the inverting terminal (−) or more, and generates an off-control signal OFFC at a low level, when the input of the non-inverting terminal (+) is smaller than the input of the inverting terminal (−).

The SR flip-flop 150 generates output at a high level, when the input of a set terminal S increases, and generates output at a low level, when the input of a reset terminal R increases. The off-control signal OFFC is inputted to the reset terminal R and a clock signal CLK that determines a switching frequency is inputted to the set terminal S. The output of the SR flip-flop 150 is a gate control signal VGC for controlling the gate driving unit 160 and outputted through an output terminal.

The gate driving unit 160 outputs a gate voltage VG at a high level for turning on the power switch M in response to a gate control signal VGC at a high level and outputs a gate voltage VE at a low level for turning off the power switch M in response to a gate control signal VGC at a low level.

The Tdis detecting unit 110 senses the time when the sensing voltage VS rapidly decreases (T1 in FIG. 4, hereafter, referred to as a Tdis end point of time) by sampling and holding the sensing voltage VS, and detects the time from the time when the sensing voltage VS increases (T0 in FIG. 4) to the Tdis end point of time, as a Tdis time.

The Tdis detecting unit 110 sets the Tdis time as a predetermined reference Tdis time, when failing to the Tdis end point of time under an abnormal status. The reference Tdis time may be set as a shorter time in the Tdis time detected in a normal status.

The current calculating unit 120 receives a current sensing voltage CS, calculates an output current IOUT, using the current sensing voltage CS at the turn-off point of time of the power switch M (T0 in FIG. 4) and the Tdis time inputted from the Tdis detecting unit 110, and generates an output current sensing voltage OCCV following the calculated output current IOUT.

The error amplifier 130 compares an output reference voltage VR with the output current sensing voltage OCCV, and generates a comparison voltage VCOMP by generating a current in accordance with the comparing result. The error amplifier 130 generates a source current, when the output current sensing voltage OCCV is smaller than the output reference voltage VR of the non-inverting terminal (+). The error amplifier 130 generates a sink current, when the output current sensing voltage OCCV is larger than the output reference voltage VR.

When the capacitor CCOM is charged by the source current supplied from the error amplifier 130, the comparison voltage VCOMP increases. The capacitor CCOM is discharged by the sink current sunken to the error amplifier 130 from the capacitor CCOM, such that the comparison voltage VCOMP decreases.

As output current IOUT decreases, the output current sensing voltage OCCV decreases and the comparison voltage increases, and as the output current IOUT increases, the output current sensing voltage OCCV increases and the comparison voltage VCOMP decreases. As the comparison voltage VCOMP increases, the on-time extends and the output current IOUT increases, whereas as the comparison voltage VCOMP decreases, the on-time is shortened, such that the output current IOUT decreases. The switch control circuit 100 keeps the output current IOUT constant in this way.

Waves of the comparison voltage VCOMP are generated in an abnormal status. For example, a short circuit may occur at the output terminal the output terminal may open in an abnormal status.

When a short circuit occurs at the output terminal, the output voltage VOUT is a short voltage, that is, a ground voltage. Therefore, the auxiliary voltage also becomes a ground voltage and the sensing voltage VS also becomes a ground voltage. Accordingly, the Tdis detecting unit 110 fails to sense the Tdis end point of time and sets the Tdis time as a reference Tdis time. Therefore, the output current sensing voltage OCCV is lower than the output reference voltage VR, such that the comparison voltage VCOMP is increased by the source current.

When a short circuit occurs at the output terminal, since the auxiliary voltage VAUX is a ground voltage, the current supplied to the capacitor CVDD is cut and the power voltage VDD also decreases. When the decreasing power voltage VDD reaches the first low-voltage reference voltage, the switch control circuit 100 quickly decreases the comparison voltage VCOMP by discharging the capacitor CCOM.

In accordance with restarting, the capacitor CVDD is charged with the input voltage VIN transmitted through a start resistor Rstart and the power voltage VDD increases. When the increasing power voltage VDD reaches the second low-voltage reference voltage, the switch control circuit 100 restarts.

When the short circuit of the output terminal is not solved, the comparison voltage VCOMP increases again and the power voltage VDD decreases again. When the power voltage VDD reaches again the first low-voltage reference voltage, the comparison voltage VCOMP decreases again.

When the output terminal opens, the output voltage VOUT increases to become a voltage at a high level. The auxiliary voltage VAUX also increases and the power voltage VDD becomes the OVP reference voltage VOVP or more. The OVP comparator 170 generates a shutdown signal at a high level. Accordingly, switching is disabled and the current sensing voltage CS and the Tdis end point of time are no longer sensed, such that the output current sensing voltage OCCV lowers than the output reference voltage VR of the non-inverting terminal (+). Accordingly, the comparison voltage VCOMP is increased by a source current.

Since the auxiliary voltage VAUX increases, when the output terminal opens, the current supplied to the capacitor CVDD increases and the power voltage VDD increases too. When the increasing power voltage VDD reaches the OVP reference voltage VOVP, switching is disabled and the control power voltage VDD reaches the first low-voltage reference voltage.

Accordingly, the switch control voltage 100 rapidly decreases the comparison voltage VCOMP by discharging the capacitor CCOM.

In accordance with restarting, the capacitor CVDD is recharged and the power voltage VDD increases. When the open of the output terminal is not solved, the comparison voltage VCOMP increases again. The increasing power voltage VDD reaches again the OVP reference voltage VOVP.

Accordingly, the switch control circuit 100 stops in response to a shutdown signal STD at a high level and the power voltage VDD decreases and reaches the first low-voltage reference voltage. Thereafter, the comparison voltage VCOMP decreases again.

As described above, the comparison voltage VCOMP fluctuates, repeating increasing and a decreasing, in an abnormal status. The SCR3 30 of the protection circuit 3 illustrated in FIG. 3 is turned on by the fluctuation of the comparison voltage VCOMP. Accordingly, the power voltage VDD is connected to the primary ground through the resistor 22 and restarting is not started. That is, the switch control circuit 100 does not restart, but it restarts when the PSR converter 4 is turned off and then turned on again.

As illustrated in FIG. 3, the protection circuit 3 turns on the SCR3 30 by detecting the fluctuation of the comparison voltage VCOMP.

The protection circuit 3 includes the SCR3 30, a detection circuit 31, three resistors R21, R22, and R23, and a BJT Q11.

The SCR3 30 includes an anode A, a cathode K, and a gate G and the gate G is connected to an emitter of the BJT Q11 and turned on when the voltage supplied to the gate is a predetermined voltage or more. The SCR3 30 is turned off, when the current supplied to the anode A is cut.

The base of the BJT Q11 is connected to the output end of the detection circuit 21, that is, the node N3 through the resistor R21. The detection voltage VD3 of the detection circuit 31 is the voltage of the node N3.

The detection circuit 31 includes two diodes D21 and D22 and two capacitors C21 and C22. The connection relationship and operation of the components of the detection circuit 31 are the same as those of the detection circuit 11 described above, so the description is not provided.

While the comparison voltage VCOMP fluctuates, the detection voltage VD3 increases to a level where the BJT Q11 can be turned on. Then, the gate G is connected to the power voltage VDD through the resistor R23. The SCR3 30 is turned on by the power voltage VDD and the power voltage VDD is connected to the ground through the resistor R22.

The SCR3 30 is turned off, when the current supplied to the anode is cut. Since there is the start resistor Rstart between one end of the capacitor CVDD and the input voltage VIN, the current path going across the start resistor Rstart and the SCR3 30 from the input voltage VIN is maintained with the SCR3 30 on.

Therefore, in restarting (for example, the input voltage VIN is supplied again to the converter), the SCR3 30 keeps turned on and the power voltage is maintained at the voltage level where the input voltage VIN is distributed in accordance with the resistance ratio between the start resistor Vstr and the resistor R22. In this status, the power voltage VDD is lower than the second low-voltage reference voltage. That is, the switch control circuit does not starts, before the SCR3 is turned off. Therefore, restarting does not start.

The SCR3 30 is turned off, when the input voltage VIN is cut by turning off the PSR converter 4. The capacitor CVDD is charged and a power voltage VDD is generated, when the PSR converter 4 is turned of again and an input voltage VIN is supplied.

As described above, the protection circuits according to exemplary embodiments decrease the power voltage VDD to the ground level, using the fluctuation of the comparison voltage VCOMP. As the power voltage VDD drops to the ground level, the switch control circuit that operates using the power voltage VDD stops the operation and switching of the power switch that controls supply of power stops. That is, a protection operation starts.

As described above, according to exemplary embodiments, it is possible to prevent power consumption due to automatic restarting that repeats while the power voltage decreases to the low-voltage reference voltage.

The abnormal status can include not only a short circuit or an open of the output terminal, but all of a short circuit between the connection pins of the switch control circuit and an open of the connection pin through the gate voltage is outputted. That is, the protection operation is generated, when the comparison voltage fluctuates due to the abnormal status.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

protection circuit 1, 2, and 3
SCR1 10, SCR2 20, SCR3 30
detection circuit (11,21, 31)
resistor (R1, R2, R3, R4, R5)
BJT (Q1, Q11)
diode (D1, D2, D3, D4, D11, D12)
capacitor (C1, C2, C3, C4)
PSR converter 4
primary wire CO1, secondary wire CO2, auxiliary wire CO3
power switch (M)
capacitor (CVDD, CCOM, CVS)
switch control circuit 100
resistor (R11, R12, R13, R21, R22, R23),
Tdis detection unit 110
current calculating unit 120
error amplifier 130
PWM comparator 140
SR flip-flop 150
gate driving unit 160
OVP comparator 170
low voltage comparator 180
internal bias circuit 190

What is claimed is:

1. A protection circuit comprising:
a detection circuit configured to generate a detection voltage that is increased by fluctuation of a comparison voltage; and
an SCR (Silicon-Controlled Rectifier Thyristor) including a gate where the detection voltage is inputted, an anode electrically connected to a power voltage, and a cathode connected to a predetermined reference voltage, the SCR configured to be turned on based on the input of the gate and turned off if a current does not flow to the anode.

2. The protection circuit of claim 1, wherein the detection circuit includes:
a first capacitor having a first end where the comparison voltage is inputted;
a first diode including an anode connected to a second end of the first capacitor;
a second capacitor connected between a cathode of the first diode and the reference voltage; and
a second diode including an anode connected to a second end of the second capacitor and a cathode connected to the second end of the first capacitor,
wherein the detection voltage is a voltage of a node between the cathode of the first diode and the second capacitor.

3. The protection circuit of claim 1, further comprising an amplifying unit configured to connect the power voltage with a gate of the SCR based on the detection voltage.

4. The protection circuit of claim 3, wherein the amplifying unit includes a BJT including a base electrically connected to the detection voltage, a collector electrically connected to the power voltage, and an emitter connected to the gate of the SCR.

5. The protection circuit of claim 4, further comprising a first resistor connected between the base of the BJT and the detection voltage.

6. The protection circuit of claim 4, further comprising a second resistor connected between the collector of the BJT and the power voltage.

7. The protection circuit of claim 1, further comprising a third resistor connected between the anode of the SCR and the power voltage.

8. A switch control circuit configured to control switching of a power supply device, which includes a primary wire, a secondary wire, a power switch connected to one end of the primary wire, and an auxiliary wire disposed at the primary side, insulated and coupled to the secondary wire, the switch control circuit comprising:
a Tdis detecting unit configured to detect a Tdis time from a time when a current is generated in the secondary wire to a time when the current flowing through the secondary wire reaches zero by using an auxiliary voltage that is the voltage between both ends of the auxiliary wire; and
a current calculating unit configured to calculate an output current of the power supply device by using the Tdis time and a current sensing voltage based on the current flowing through the power switch to generate an output power sensing voltage,
wherein the switch control circuit is configured to generate a power voltage by using the auxiliary voltage and a comparison voltage based on the difference between the output current sensing voltage and a predetermined output reference voltage, and is connected to a protection circuit that is configured to generate a detection voltage increased by fluctuation of the comparison voltage in an abnormal status and configured to control the power voltage to a predetermined reference voltage when the detection voltage reaches a predetermined
protection operation threshold level.

9. The switch control circuit the of claim 8, wherein the protection circuit includes an SCR (Silicon-Controlled Rectifier Thyristor) that includes a gate to which the detection voltage is inputted, an anode electrically connected to the power voltage, and a cathode connected to the reference voltage, turned on/off in response to the input of the gate.

10. The switch control circuit of claim 9, wherein the protection circuit includes:
a first capacitor having a first end where the comparison voltage is inputted;
a first diode including an anode connected to a second end of the first capacitor;
a second capacitor connected between a cathode of the first diode and the reference voltage; and
a second diode including an anode connected to a second end of the second capacitor and a cathode connected to the second end of the first capacitor,
wherein the detection voltage is a voltage of a node between the cathode of the first diode and the second capacitor.

11. The switch control circuit of claim 9, wherein the protection circuit further includes an amplifying unit configured to connect the power voltage with a gate of the SCR based on the detection voltage.

12. The switch control circuit of claim 11, wherein the amplifying unit includes a BJT including a base electrically connected to the detection voltage, a collector electrically connected to the power voltage, and an emitter connected to the gate of the SCR.

13. The switch control circuit of claim 8, wherein the Tdis detecting unit is configured to sense an end time of the Tdis time when the sensing voltage rapidly decreases, and configured to detect the time from a time when the sensing voltage begins to increase to the end time of the Tdis time as the Tdis time, by sampling and holding a sensing voltage from the auxiliary voltage which is divided by resistors, and configured to set a predetermined reference Tdis time as the Tdis time, when failing to sense the end time of the Tdis time in the abnormal status.

14. The switch control circuit of claim 13, wherein the current calculating unit is configured to generate the output current sensing voltage based on the result of multiplying the Tdis time by the current sensing voltage at the turn-off point of time of the power switch.

15. The switch control circuit of claim 8, further comprising a low-voltage comparing unit configured to generate a power status signal based on the result of comparing the power voltage with a first low-voltage reference voltage, when the power voltage decreases, or the result of comparing the power voltage with a second low-voltage reference voltage, when the power voltage increases.
wherein the switch control circuit is configured to discharge the capacitor storing the comparison voltage when the power status signal is at a disabled level.

16. The switch control circuit of claim 8, further comprising:
an OVP (Over Voltage Protection) comparator configured to generate a shutdown signal based on the result of comparing the power voltage with a predetermined overvoltage reference voltage,
wherein the switch control circuit is configured to discharge the capacitor storing the comparison voltage when the power voltage reaches a first low-voltage reference voltage due to the shutdown signal.

17. A power supply device comprising:
a transformer that includes a primary wire and a secondary wire;
a power switch that is connected to one end of the primary wire;
an auxiliary wire that is disposed at the primary side, insulated and coupled to the secondary wire;
a first capacitor that is connected to an auxiliary voltage, which is the voltage between both ends of the auxiliary wire, through a diode, and stores a power voltage;
a switch control circuit configured to detect a Tdis time from a time when a current is generated in the secondary wire to a time when the current flowing through the secondary wire reaches zero by using the auxiliary voltage, configured to calculate an output current of the power supply device by using the Tdis time and a current sensing voltage based on the current flowing through the power switch to generate an output power sensing voltage, and configured to generate a comparison voltage based on the difference between the output current sensing voltage and a predetermined reference voltage; and
a protection circuit configured to generate a detection voltage increased by fluctuation of the comparison voltage in an abnormal status, and configured to control the power voltage to a predetermined reference voltage when the detection voltage reaches a predetermined protection operation threshold level.

18. The device the of claim 17, wherein the protection circuit includes an SCR (Silicon-Controlled Rectifier Thyristor) that includes a gate that the detection voltage is inputted, an anode electrically connected to the power voltage, and a cathode connected to the reference voltage, the SCR configured to be turned on/off in response to the input of the gate.

19. The device of claim 18, wherein the protection circuit includes:
a first capacitor having a first end where the comparison voltage is inputted;
a first diode including an anode connected to a second end of the first capacitor;
a second capacitor connected between a cathode of the first diode and the reference voltage; and
a second diode including an anode connected to a second end of the second capacitor and a cathode connected to the second end of the first capacitor,
wherein the detection voltage is a voltage of a node between the cathode of the first diode and the second capacitor.

20. The device of claim 18, wherein the protection circuit further includes an amplifying unit is configured to connect the power voltage with a gate of the SCR based on the detection voltage.
